(19) United States
(12) Patent Application Publication
(10) Pub. No.: US 2023/0373659 A1
(43) Pub. Date: Nov. 23, 2023

(54) Edge registration for shearless extendible booms

(71) Applicant: M.M.A. Design, LLC, Louisville, CO (US)

(72) Inventors: Alexi Rakow, Boulder, CO (US); Lyn Eric Ruhl, Louisville, CO (US)

(21) Appl. No.: 18/320,622

(22) Filed: May 19, 2023

Related U.S. Application Data
(60) Provisional application No. 63/343,751, filed on May 19, 2022.

(51) Int. Cl. B64G 1/22

(52) U.S. Cl. CPC B64G 1/222

(57) ABSTRACT

A shearless boom includes a first boom shell, a second boom shell, and a flexible sheath encasing both. Each of the first and second boom shells extends along and about a respective longitudinal axis, has lateral longitudinal edges, and defines respective first and second concavities in cross section. The first and second longitudinal axes are parallel, the first concavity faces the second concavity, and the lateral longitudinal edges of the first boom shell are aligned with and oppose the lateral longitudinal edges of the second boom shell, respectively. A first structural form is associated with the first boom shell and a second structural form is associated with the second boom shell. The first and second structural forms are configured to form an interface with each other that resists torsional movement of the shearless boom and inhibits slippage between corresponding lateral longitudinal edges of first and second boom shells.

### CROSS REFERENCE TO RELATED APPLICATIONS

This application claims the benefit of priority pursuant to 35 U.S.C. § 119(e) of U.S. provisional application No. 63/343,751 filed 19 May 2022 entitled “Edge registration for shearless extendible booms,” which is hereby incorporated herein by reference in its entirety.

### STATEMENT REGARDING FEDERALLY SPONSORED RESEARCH OR DEVELOPMENT

This invention was made with government support under contract number 80NSSC20CO236 awarded by the National Aeronautics and Space Administration. The government has certain rights in the invention.

### TECHNICAL FIELD

The technology described herein relates to the manufacture of extendible booms for extraterrestrial deployment from a furled to an unfurled state.

### BACKGROUND

Extendible booms are used in extraterrestrial and terrestrial applications to provide strong, resilient, lightweight support for deployment of flexible material of large surface area. For example, an arrangement of extendible booms extending from a satellite may provide a framework for an array of thin film solar panels to power the satellite. In other applications, an arrangement of extendible booms may support a fabric or flexible membrane functioning as a solar sail to provide thrust to a satellite or as a shield to reflect radiation. The booms are rolled up or furled for launch and unfurl once the satellite deploys in orbit or on an exoplanetary excursion.

The information included in this Background section of the specification, including any references cited herein and any description or discussion thereof, is included for technical reference purposes only and is not to be regarded subject matter by which the scope of the invention as defined in the claims is to be bound.

### SUMMARY

A shearless extendible boom design of implementations disclosed herein may include a combination of first and second boom shells restrained within a flexible sheath encasing them both. The first boom shell may extend along and about a first longitudinal axis, have lateral longitudinal edges, and define a first concavity in cross section. A first structural form may be associated with the first boom shell. The second boom shell may extend along and about a second longitudinal axis, have lateral longitudinal edges, and define a second concavity in cross section. A second structural form may be associated with the second boom shell. The first and second longitudinal axes are parallel, the first concavity faces the second concavity, and the lateral longitudinal edges of the first boom shell are aligned with and oppose the lateral longitudinal edges of the second boom shell, respectively. The first structural form and the second structural form are configured to form an interface with each other such that the interface resists torsional movement of the shearless extendible boom and inhibits slippage between corresponding lateral longitudinal edges of first boom shell and the second boom shell.

In another implementation, a method of maintaining lateral edge registration between a first boom shell and a second boom shell forming a shearless extendible boom is disclosed. A first structural form associated with the first boom shell may be provided. A second structural form associated with the second boom shell may also be provided. The first structural form and the second structural form may be configured to form an interface with each other such that the interface resists torsional movement of the shearless extendible boom and inhibits slippage between corresponding lateral edges of first boom shell and the second boom shell.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. A more extensive presentation of features, details, utilities, and advantages of the present invention as defined in the claims is provided in the following written description of various embodiments and implementations and illustrated in the accompanying drawings.

### BRIEF DESCRIPTION OF THE DRAWINGS

The disclosure will be readily understood by the following detailed description in conjunction with the accompanying drawings, wherein like reference numerals designate like structural elements.

The use of cross-hatching or shading in the accompanying figures is generally provided to clarify the boundaries between adjacent elements, e.g., when shown in cross section, and also to facilitate legibility of the figures. Accordingly, neither the presence nor the absence of cross-hatching or shading conveys or indicates any preference or requirement for particular materials, material properties, element proportions, element dimensions, commonalities of similarly illustrated elements, or any other characteristic, attribute, or property for any element illustrated in the accompanying figures.

Additionally, it should be understood that the proportions and dimensions (either relative or absolute) of the various features and elements (and collections and groupings thereof) and the boundaries, separations, and positional relationships presented therebetween, are provided in the accompanying figures merely to facilitate an understanding of the various embodiments described herein and, accordingly, may not necessarily be presented or illustrated to scale, and are not intended to indicate any preference or requirement for an illustrated embodiment to the exclusion of embodiments described with reference thereto.

FIG. 1A is an isometric view of two flared, shearless boom shells according to example implementations disclosed herein.

FIG. 1B is a cross-section view of the flared, shearless boom shells of FIG. 1A held together within a flexible sheath in an expanded and unfurled configuration according to example implementations disclosed herein.

FIG. 1C is an isometric view of the flared, shearless boom shells within the flexible sheath of FIG. 1B in a compressed and furled configuration according to example implementations disclosed herein.

FIG. 1D is a cross-section view of the flared, shearless boom shells within the flexible sheath in the compressed and furled configuration of FIG. 10 according to example implementations disclosed herein.

FIG. 2A is an isometric view of a pair of shearless boom shells without a sheath and registered together with stitching according to example implementations disclosed herein.

FIG. 2B is a side elevation of the inner walls of the pair of shearless boom shells of FIG. 2A stitched together as depicted in FIG. 1A with catch cords shown along the interior walls according to example implementations disclosed herein.

FIG. 2C is a cross-section view of the pair of shearless boom shells of FIG. 2A within a flexible sheath in a collapsed configuration indicating the slack in the stitching according to example implementations disclosed herein.

FIG. 3A is an isometric view of two shearless boom shells with corrugated edges held together within a flexible sheath according to example implementations disclosed herein.

FIG. 3B is an enlarged isometric view of end portions of two shearless boom shells with corrugated edges of FIG. 3A according to example implementations disclosed herein.

FIG. 3C is a cross-section view of the shearless boom shells corrugated edges within the flexible sheath of FIG. 3A in an expanded and unfurled configuration according to example implementations disclosed herein.

FIG. 3D is an isometric view of the shearless boom shells with corrugated edges within the flexible sheath of FIG. 3A in a compressed and furled configuration according to example implementations disclosed herein.

FIG. 3E is a cross-section view of the flared, shearless boom shells within the flexible sheath in the compressed and furled configuration of FIG. 3D according to example implementations disclosed herein.

FIG. 4A is an isometric view of a male section and a female section of an endcap for a shearless boom constrained within a flexible sheath according to example implementations disclosed herein.

FIG. 4B is top plan view of the male section and the female section of the endcap of FIG. 4A in a joined and registered configuration when the boom is fully unfurled according to an example implementation disclosed herein.

FIG. 4C is an isometric view of the male section of the end cap according to example implementations disclosed herein.

FIG. 4D is an isometric view of the female section of the end cap according to example implementations disclosed herein.

FIG. 4E is an isometric view of the boom in a compressed and furled configuration in which the male section of the cap is partially joined to the female section of the cap in an unregistered position according to example implementations disclosed herein.

### DETAILED DESCRIPTION

For purposes of description herein, it is to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise. The word “exemplary” is used herein to mean “serving as an example, instance, or illustration.” Any implementation described herein as “exemplary” is not intended to be construed as preferred or advantageous over other implementations.

Rollable and deployable booms made from thin-shell materials may be used in a wide range of space and terrestrial applications. Various embodiments of these booms include “carpenter tape” or tape-spring booms, slit-tubes, collapsible tubular masts, or storable tubular extendible members. These elements provide superior specific stiffness, while packaging into low stowed volumes, making them ideal structural elements for space missions. These booms may be made from metal or composite laminates which consist of polymer and/or fiber materials arranged in various orientations for increased stiffness, strength, and packaging and deployment performance. Whereas deployable booms with open cross-sections have relatively low torsional stiffness, deployable booms that have closed cross-sections exhibit superior torsional stiffness and specific stiffness. In some implementations, a closed cross-section, rollable, and deployable boom is formed by adjacently aligning and restraining the lateral edges of two thin, longitudinally-extending shells of constant curvature (e.g., tape spring forms) to construct a tube structure with circular, oval, elliptical, or similar oblong cross sections.

It may be appreciated that when spooled or coiled, a rollable boom or other similar design may store a large amount of strain energy and may be biased to unfurl. In some instances, the boom can uncontrollably expand (blossom) inside the deployer mechanism during deployment. In some embodiments, a rollable boom may be made of a “bistable” material. Bistability indicates that the rollable boom has a secondary stable low energy state in the coiled configuration, similar to a tape measure or a toy “slap bracelet.” In general, bistable booms store less strain energy when coiled and have a slower more controllable and coherent deployment. Bistable rollable booms may be achieved through combinations of the thin-shell cross-section geometry and the composite laminate chosen for each thin-shell segment. The stable, low-energy state in the coiled configuration of a bistable rollable boom may simplify the stowage process with a reduction in the size, mass, and complexity of the deployment mechanism, as well as yield a more coherent and controllable extension of the boom upon release of its constraints when compared to non-bistable booms.

As noted above, rollable booms may be formed of two opposing, longitudinally-extending, constant-curvature shells that define a lenticular cross section. In some implementations, the lateral edges of the opposing shells are adhered or fused together along the length of the boom. When furling a boom with joined edges for storage during transport, the opposing shells are flattened (i.e., the curvature is suppressed and the lateral edges extend to result in a wider, flat, two-layer tape for ease of rolling. The outer shell of the roll will have a larger diameter than the inner shell of the roll with each revolution of the boom around a center spindle. This difference in diameter results in significant shear force placed upon the edge bonds between the shells and related longitudinal compression of the inner shell. Presuming the strength of the bond between the lateral edges of the inner and outer shells is greater than the shear forces acting on the bond, together the related compression force causes micro-buckles in the inner shell to maintain edge registration with the outer shell to which it is attached.

Some designs for rollable booms are configured to avoid the shear stress placed on edge bonding constructions and related compressive forces, and thereby reduce strain on and help maintain the integrity of the inner sleeve. In one embodiment, the lateral edges of the inner and outer shells of a rollable boom are not bonded together, but rather are registered with each other and restrained against each other with an external constraint. In some designs, the inner and outer shells of a rollable boom may be placed within an elongate tube of flexible material, e.g., a plastic sleeve. (See, e.g., U.S. Pat. No. 98,631,4862.) In this “shearless” boom design, the plastic sleeve allows the inner and outer shells to slide longitudinally with respect to each other when being furled and unfurled. The cross-sectional diameter of the sleeve is generally congruent with a diameter of the tubular boom formed by the inner and outer shells when unfurled and constrains the lateral edges of the inner and outer shells against each other to maintain the tubular form of the boom. It should be appreciated that the distal end of the inner shell will extend further than the distal end of the outer shell when the boom is furled due to the difference in diameters, and thus circumference, between the inner shell and outer shell in each layer of the rolled boom configuration.

The sleeve further allows the inner and outer shells to flatten against each other. Because of its congruent diameter, the flexible sleeve may also accommodate and conform to the flattened configuration of the inner and outer shells when furling. Minimal thickness and elasticity of the material forming the flexible sleeve do not interfere with or add substantial thickness to the furled boom roll. For example, the flexible sleeve may be made of a polyethylene or similar plastic material with a low coefficient of friction to ensure the inner and outer shells slide freely within it and with moderate elasticity to provide flexibility while maintaining adequate strain resistance to hold the inner and outer shells together.

While use of a constraining flexible sleeve avoids the shear and compression forces on the inner sleeve during furling, edge registration of the inner and outer shells in an unfurled configuration of the boom may be difficult to maintain. Opposing lateral edges of the inner and outer shells are difficult to align, even when constrained. The inner and outer shells are thin in order to flatten and furl. Placing and maintaining sharp, knife-like edges against each other often results in the edges slipping past each other. Further, the materials forming the inner and outer shells of the booms may be selected for low friction properties to promote slippage of the inner shell with respect to the outer shell during furling and unfurling. A lack of stiction between the lateral edges of the upper and lower shells similarly increases the difficulty of maintaining registration. When the lateral edges are not aligned, torsional stiffness is reduced and the strength and integrity of the boom in an unfurled configuration is compromised.

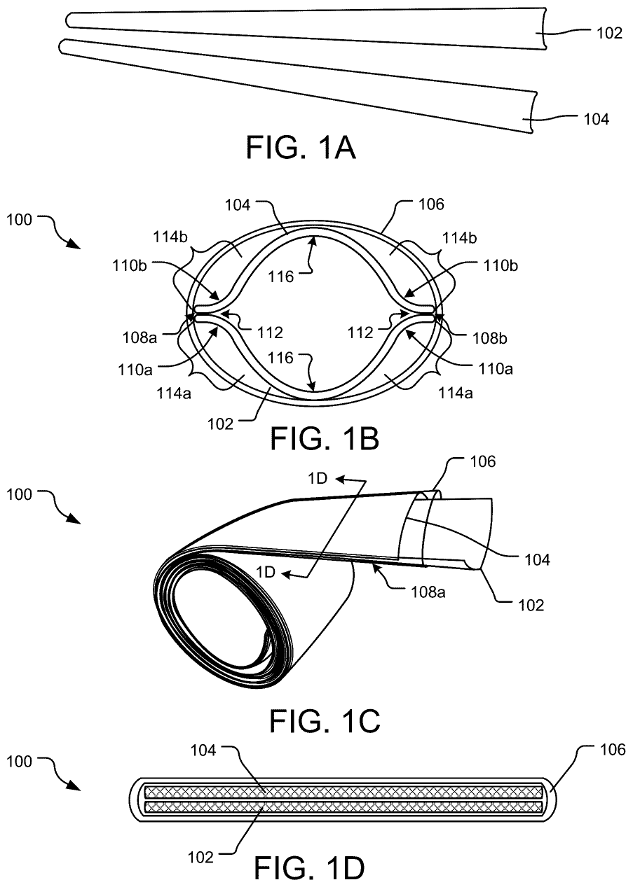

The present disclosure describes several implementations for addressing these concerns with shearless boom construction. An example of one proposed solution to these concerns is shown in FIGS. 1A-1D. FIG. 1A depicts an exemplary implementation of a shearless boom 100. FIG. 1B depicts the shearless boom 100 in cross-section transverse to the longitudinal axis of the shearless boom 100. The shearless boom 100 may be composed of a first boom shell 102 and a second boom shell 204 positioned opposing the first boom shell 102. The first boom shell 102 and the second boom shell 104 are formed as longitudinally-extending shells or split tubes defining a curvature that together construct a tube structure with an oblong cross section when positioned opposite each other with convex sides of the first boom shell 102 and the second boom shell 104 facing each other. Each of the first boom shell 102 and the second boom shell 104 may be constructed as laminates of layers of polymers and/or fiber materials arranged in various crosswise orientations to increase the strength of the boom. For example, boom laminates may be made from materials such as glass fiber reinforced plastic, carbon fiber reinforced plastic, carbon fiber reinforced polymer, fiber reinforced plastics, Kevlar reinforced plastic, etc.

The first boom shell 102 and the second boom shell 104 may be encased within a flexible sleeve or sheath 106, e.g., of a thin plastic material, that retains the first boom shell 102 and the second boom shell 104 against and with respect to each other. For example, the flexible sheath 106 may be made of a polyethylene or similar plastic material with a low coefficient of friction to ensure the inner and outer shells slide freely within it and with moderate elasticity to provide flexibility while maintaining adequate strain resistance to hold the inner and outer shells together. The term “shearless” is used herein to indicate that the first boom shell 102 and the second boom shell 104 are not bonded to or otherwise longitudinally restrained with respect to each other such that the first boom shell 102 and the second boom shell 104 can move longitudinally with respect to each other when furling and unfurling. Allowing relative longitudinal motion between the first boom shell 102 and the second boom shell 104 prevents significant shear force from being placed on the inner shell (e.g., the first boom shell 102 as shown in FIG. 10) of the shearless boom 100 when in a furled state.

As shown in the cross-section view of FIG. 1B, the first boom shell 102 and the second boom shell 104 do not maintain a constant curvature over the lateral dimension from a first edge 108a to a second edge 108b. Rather each lateral end of the first boom shell 102 is formed with a convex curve 110a defining flared sections 114a. Similarly, each lateral end of the second boom shell 104 is formed with a convex curve 110b defining flared sections 114b. The transition to the convex curve 110a, 110b in such flared sections 114a, 114b begins closer to the first edge 108a or the second edge 108b on respective lateral ends than to an apex 116 of the primary concave curve of each of the first boom shell 102 and the second boom shell 104. A radius of curvature of the convex curves 110 is much larger than a radius of curvature of the primary concave curves of the first boom shell 102 and the second boom shell 104.

The curvature of the convex curves 110a, 110b may be determined in consideration of several parameters. First, the curvature should not be so sharp (i.e., the radius should not be so small) as to weaken the walls of the first and second boom shells 102, 104. If the radius of curvature is too extreme, the flared sections 114a, 114b will encounter significant strain when flattened during furling and while a stored configuration. Depending upon the material forming the first and second boom shells 102, 104, the flared sections 114a, 114b may be brittle and break under the induced strain of flattening if the convex curves 110a, 110b are too severe.

Second, the circumferential perimeter about a cross section of the first and second boom shells 102, 104 should remain slightly less than the cross-sectional perimeter of the flexible sheath 106 to avoid strain on the flexible sheath 106 when the shearless boom 100 is flattened in a furled state, e.g., as shown in FIGS. 10 and 1D. As the radius of curvature of the flared sections 114a, 114b decreases, the widths of the external surface of the walls of the first and second boom shells 102, 104 along a transverse cross-section increases. In a problematic example, when the convex curves are too sharp, the shearless boom may fit within the flexible sheath in an unfurled state due to the convex curvature “pinching” the first and second edges laterally inward toward the center of the boom. However, when flattened in a furled state, the widths of the first and second boom shells could together be longer than the perimeter of the flexible sheath due to the increase in lateral surface width caused by introduction of the convex curves. The greater lateral width may stretch and strain the flexible sheath in the furled state such that it is too large in diameter to appropriately retain the first and second boom shells against each other when unfurled, or even tear the flexible sheath due to the strain. Therefore, selection of a radius for the convex curves 110a, 110b should be balanced between a value too large for measurable improvement in maintaining edge registration and too small such that the flexible sheath 106 is strained in a furled configuration of the shearless boom 100.

The inner surfaces of the flared sections 114a of the first boom shell 102 are positioned opposite from the inner surfaces of the flared sections 114b of the second boom shell 104 such that the lateral edges of each of the first boom shell 102 and the second boom shell 104 engage each other at contact interfaces 112. The slightly outward convex curves 110a, 110b in the first boom shell 102 and the second boom shell 104, respectively, forming the flared sections 114a, 114b improves edge-on-edge contact between the first boom shell 102 and the second boom shell 104. As shown in FIG. 1B, the cross section of the first boom shell 102 and the second boom shell 104 within the flexible sheath 106 in an unfurled configuration is similar to a “lemon shape.” The flared sections 114a, 114b mitigate the “knife edge” contact of prior boom shell designs with only a primary concave curvature and thereby reduce the likelihood of slippage at the contact interfaces 112. Greater stability and reduced slippage between the first boom shell 102 and the second boom shell 104 at the contact interfaces 112 improves the torsional stiffness and stability of the shearless boom 100.

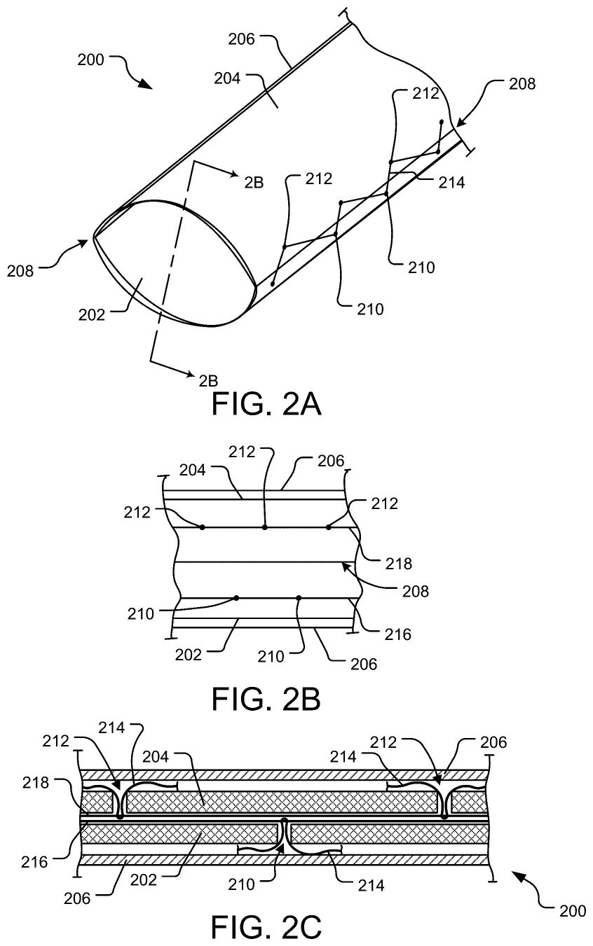

An alternative exemplary configuration and methodology for maintaining edge registration between a first boom shell 202 and a second boom shell 204 in a shearless boom 200 is depicted in FIGS. 2A, 2B, and 2C. As in the prior configuration, the first boom shell 202 and the second boom shell 204 are encased within a flexible sleeve or sheath 206, e.g., of a thin plastic material, that retains the lateral edges of the first boom shell 202 and the second boom shell 204 against and with respect to each other at respective seams 208. In addition, the respective lateral edges of the first boom shell 202 and the second boom shell 204 are held in registration along the seams 208 by stitching them together with thread or cord.

As shown in FIG. 2A, a first series of holes 210 are defined within the lateral walls of the first boom shell 202 and are spaced apart longitudinally from each other as well as apart from and adjacent to the lateral edges at the seams 208. A second series of holes 212 in the second boom shell 204 and are spaced apart longitudinally from each other as well as apart from and adjacent to the lateral edges at the seams 208. The first series of holes 210 may be longitudinally offset from the second series of holes 212, such that each hole in the first series of holes 210 is positioned longitudinally between two adjacent holes in the second series of holes 212 and vice versa (except for the final holes on the distal and proximal ends). A top stitch 214 is provided by a thread (which further encompasses, e.g., a cord, filament, fiber, strand, string, line, yarn, twine, etc.) that alternates or zigzags between adjacent holes in the first series of holes 210 in the first boom shell and the second set of holes 212 on the second boom shell 204 across the seams 208 on each lateral side of the shearless boom 200. As depicted in the interior, side elevation view of FIG. 2B, the top stitch 214 passes through each of the holes in the first and second series of holes 210, 212 and loops around respective bottom threads 216, 218 (which further encompass, e.g., cords, filaments, fibers, strands, strings, lines, yarns, twines, etc.) running longitudinally within the shearless boom 200 along the interior walls of each of the first boom shell 202 and the second boom shell 204 and aligned with respective first and second series of holes 210, 212. The top stitch 214 exits each hole of the first and second sets of holes 210, 212 it entered after looping around a respective bottom thread 216, 218, which thereby retain the top stitch at each hole position in the first and second sets of holes 210, 212 to create the zig-zag pattern.

In the unfurled state, the top stitch 214 may be snug or taught against the outside walls of the first boom shell 202 and the second boom shell 204 along and across the seam 208. In this configuration, the stitching along the seams 208 maintains registration between the respective lateral edges of the first boom shell 202 and the second boom shell 204. In the furled state when the first boom shell 202 and the second boom shell 204 are flat and compressed against each other as shown in the cross-section view of FIG. 2C, the top stitches 214 and the bottom threads 216, 218 are slack. The slack in the top stitches 214 and the bottom threads 216, 218 allow the first boom shell 202 and the second boom shell 204 to slide against each other during furling and avoid shear forces between the first boom shell 202 and the second boom shell 204 and micro-buckling of the first boom shell 202 (the inner boom shell). The flexible sheath 206 around the first boom shell 202 and the second boom shell 204 and the top stitches 214 further holds the first boom shell 202 and the second boom shell 204 together to form an embodiment of a shearless boom 200 with improved edge registration.

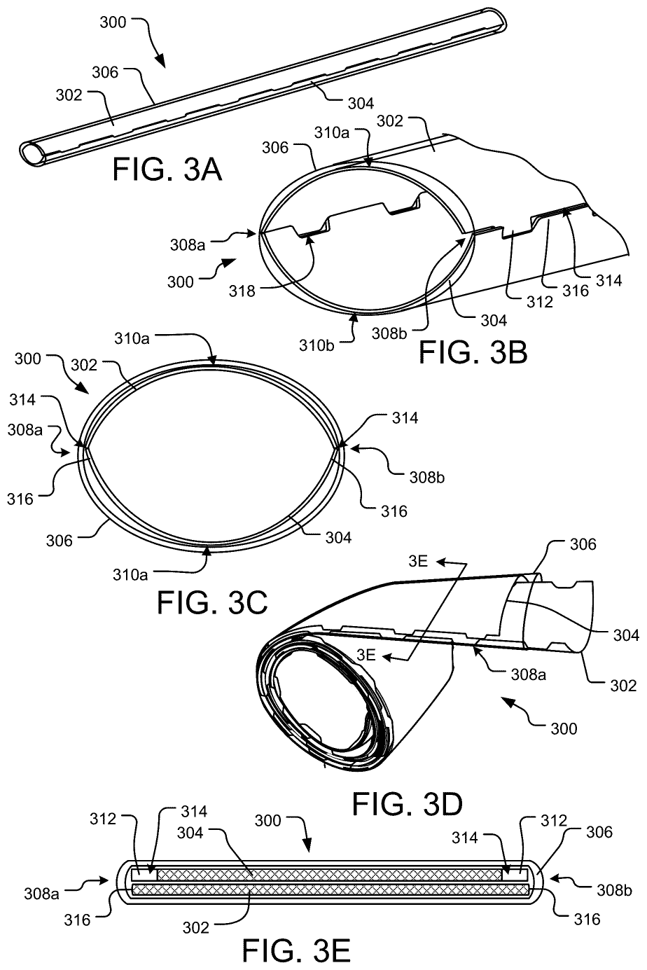

An example of another design for a shearless boom 300 is shown in FIGS. 3A-3E. FIG. 3B depicts an enlarged view of one end of the shearless boom 300 shown in FIG. 3A. FIG. 3C depicts the shearless boom 300 in cross-section transverse to the longitudinal axis of the shearless boom 300. The shearless boom 300 may be composed of a first boom shell 302 and a second boom shell 304 positioned opposing the first boom shell 302. The first boom shell 302 and the second boom shell 304 are formed as longitudinally-extending shells or split tubes defining convex curvatures 310a, 310b that together construct a tube structure with an oblong cross section when positioned opposite each other with convex sides of the first boom shell 302 and the second boom shell 304 facing each other. Each of the first boom shell 302 and the second boom shell 304 may be constructed of metal or as laminates of layers of polymers, fiber materials, and/or combinations thereof arranged in various crosswise orientations to increase the strength of the boom. For example, boom laminates may be made from materials such as glass fiber reinforced plastic, carbon fiber reinforced plastic, carbon fiber reinforced polymer, fiber reinforced plastics, Kevlar reinforced plastic, etc.

The first boom shell 302 and the second boom shell 304 may be encased within a flexible sleeve or sheath 306, e.g., of a thin plastic material, that retains the first boom shell 302 and the second boom shell 304 against and with respect to each other. For example, the flexible sheath 306 may be made of a polyethylene or similar plastic material with a low coefficient of friction to ensure the inner and outer shells slide freely within it and with moderate elasticity to provide flexibility while maintaining adequate strain resistance to hold the inner and outer shells together. The term “shearless” is used herein to indicate that the first boom shell 302 and the second boom shell 304 are not bonded to or otherwise longitudinally restrained with respect to each other such that the first boom shell 302 and the second boom shell 304 can move longitudinally with respect to each other when furling and unfurling. Allowing relative longitudinal motion between the first boom shell 302 and the second boom shell 304 prevents significant shear force from being placed on the inner shell (e.g., the first boom shell 302 as shown in FIG. 10) of the shearless boom 300 when in a furled state.

The lateral edges 308a of the first boom shell 302 may be corrugated in a series of alternating teeth or tabs 312 and slots or recesses 314. The tabs 312 and recesses 314 may be formed in a repeating pattern of the same size (length and depth) and shape or may be formed in arbitrary sizes. The lateral edges 308b of the second boom shell 304 may also be corrugated in a symmetric series of alternating teeth or tabs 316 and slots or recesses 318. The tabs 316 and recesses 318 may be formed in a repeating pattern of the same size (length and depth) and shape or may be formed in arbitrary sizes. However, the size, shape, and location of the tabs 312 along the first boom shell 302 may be congruent with the size, shape, and location of the recesses 318 of the second boom shell 304 such that the tabs 312 symmetrically fit within the recesses 318 along the length of the shearless boom 300 when the shearless boom 300 is fully unfurled. Similarly, the size, shape, and location of the tabs 316 along the second boom shell 304 may be staggered with respect to, but congruent with, the size, shape, and location of the recesses 314 of the first boom shell 302 such that the tabs 316 symmetrically fit within the recesses 314 along the length of the shearless boom 300 when the shearless boom 300 is fully unfurled.

It may be understood that the tabs 312, 316 and recesses 314, 318 need not be rectangular, or slightly trapezoidal, in form as shown in the figures. Rather, the lateral edges 308a, 308b of the first and second boom shells 302, 304 may take on other shapes and forms, for example, triangular or as a rounded curve or scallop, to create corrugated edges as long as the tabs and recesses on opposing lateral edges 308a, 308b align when the shearless boom 300 is fully unfurled. Further, the paired tab 312 and recess 318 need not be of different lengths than the paired tab 316 and recess 314, but rather all lengths could be congruent.

Recall in a shearless design, the first boom shell 302 and the second boom shell 304 are not bonded to or otherwise longitudinally restrained with respect to each other such that the first boom shell 302 and the second boom shell 304 can move longitudinally with respect to each other when furling and unfurling. As shown in FIG. 3D, the distal end of the first boom shell 302 comprising the inner diameter of each of the windings of the furled shearless boom 300 extends distally further than the second boom shell 304 comprising the outer diameter of each winding. This results from the difference in diameters between the windings of the first boom shell 302 and the second boom shell 304, the former being smaller in dimension than the latter. The distal end of the flexible sheath 306 may be generally aligned with the distal end of the second boom shell 304 resulting from longitudinal bunching of the inner surface of the flexible sheath 306 during furling. In this configuration, the distal ends of each of the first and second boom shells 302, 304 define a separation distance 322.

The corresponding lengths of the tabs 312, 316 and recesses 314, 318 may be chosen to ensure that opposing tabs 312, 316 interface and slide against each other when the shearless boom 300 is being unfurled to prevent interlocking between the lateral edges 308a, 308b of the first and second boom shells 302, 304 before the shearless boom 300 is fully unfurled. The relative lengths of the opposing tabs 312, 316 may be selected such that a length 320 of a long tab, e.g., tab 316, is congruent with or slightly longer than the separation distance 322 between the first boom shell 302 and the second boom shell 304. The other tab 312 may be of shorter length than or equivalent in length to the long tab 316. In this way, the tabs 312, 316 will slide against each other as the shearless boom 300 unfurls and prevent premature interlocking of the respective tabs 312, 316 and recesses 314, 318 of the first and second boom shells 302, 304. When furling the shearless boom 300, an external compression force between the first and second boom shells 302, 304 may need to be initially applied to unlock the respective tabs 312, 316 and recesses 314, 318. However, if the edges of the respective tabs 312, 316 and recesses 314, 318 are sufficiently angled (e.g., trapezoidal sidewalls) or curved (e.g., undulating scallops) with respect to each other, then the longitudinal force during furling may cause the edges to easily slip past each other with minor shear forces until face surfaces of the tabs 312, 316 are in contact with each other to allow for shearless respective movement (although with low friction) between the first and second boom shells 302, 304.

In general, the corrugated lateral edges 308a of the first boom shell 302 are positioned opposite from the corrugated lateral edges 308b of the second boom shell 104 such that the lateral edges 308a, 308b of each of the first boom shell 302 and the second boom shell 304 engage each other at their interface when the shearless boom 300 is unfurled. The interfaces between the tabs 312, 316 and the corresponding, respective recesses 314, 318 improves edge-on-edge contact between the first boom shell 302 and the second boom shell 304 as shown in FIG. 3B. The corrugated lateral edges 308a, 308b mitigate the “knife edge” contact of prior boom shell designs with flat edges and thereby reduce the likelihood of slippage at the contact interfaces of the first and second boom shells 302, 304. Greater stability and reduced slippage between the first boom shell 302 and the second boom shell 304 at the contact interfaces improves the torsional stiffness and stability of the shearless boom 300.

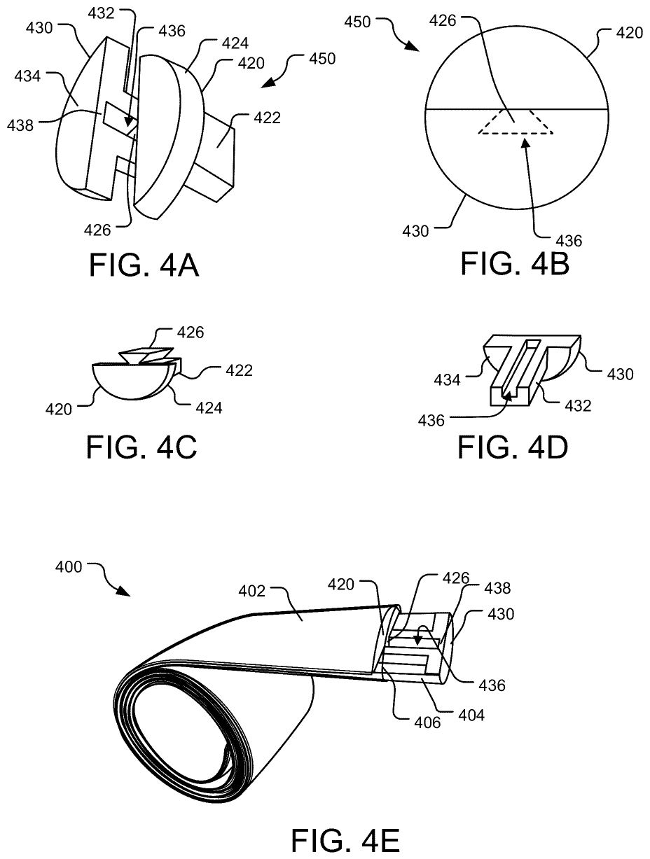

Another methodology for aiding and maintaining edge registration between a first boom shell 402 and a second boom shell 404 in various designs of shearless booms 400 (e.g., shearless booms 100, 200, and 300 described herein) is provided in an exemplary two-part end cap 450 depicted in FIGS. 4A-4E. The end cap 450 is composed of a male half 420 and a female half 430 that fit and moveably connect together as further described herein.

The male half 420 of the cap 450 may be of unitary construction (e.g., a molded plastic piece) is composed of a post 422 of a first radius and a bung portion 424 of a second radius that is larger than the first radius. The post 422 is formed as a half- or semi-cylinder with a tongue 426 extending longitudinally along the flat surface of the semi-cylinder form of the post 422. The tongue 426 may be formed as a key-shape, for example, as a trapezoidal dovetail in cross section normal to the longitude of the post 422. The bung portion 424 seats at one end of the post 422 and may be in the form of a half- or semi-circular disk of a longitudinal thickness less than the length of the post 422. The bung portion 434 may further define a part of the tongue 426, which extends along the flat face of the semi-circular disk to a position substantially congruent with the top surface of the bung portion 424. The flat face of the semi-circular disk defining the bung portion 424 may be positioned flush with flat surface of the semi-cylinder form of the post 422 with the radial centers of the post 422 and the bung portion 424 concentric with each other. The curved edge of the bung portion 424 thus forms a semi-circular flange extending outward from the curved surface of the semi-cylinder form of the post 422.

The female half 430 of the cap 450 may be of unitary construction (e.g., a molded plastic piece) composed of a post 432 of a first radius and a bung portion 434 of a second radius that is larger than the first radius. The post 432 is formed as a half- or semi-cylinder with a groove 436 extending longitudinally within the flat surface of the semi-cylinder form of the post 432. The groove 436 may be formed as a keyhole-shape, for example, as a trapezoidal rabbet in cross section normal to the longitude of the post 432. The key-hole shape of the groove 436 may be designed as a complement of and to receive the tongue 426 of the male half 420. The bung portion 434 seats at one end of the post 432 and may be in the form of a half- or semi-circular disk of a longitudinal thickness less than the length of the post 432. The bung portion 434 may further define a part of the groove 436, which extends within the flat face of the semi-circular disk. The flat face of the semi-circular disk defining the bung portion 434 may be positioned flush with flat surface of the semi-cylinder form of the post 432 with the radial centers of the post 432 and the bung portion 434 concentric with each other. The curved edge of the bung portion 434 thus forms a semi-circular flange extending outward from the curved surface of the semi-cylinder form of the post 432. A stop panel 438 may cover the end of the groove 436 on the top surface of the bung portion 434. The stop panel 438 may be a separate panel covering the end of the groove 436 or it may be the entirety of the top surface of the bung portion 424 through which the groove 436 does not extend. In other words, the groove 436 may be formed as a “blind hole” with respect to the top surface of the bung portion 434 of the female half 430.

As depicted in FIG. 4E, a shearless boom 400 is in a furled configuration. The distal end of the first boom shell 402 comprising the inner diameter of each of the windings of the furled shearless boom 400 extends distally further than the second boom shell 404 comprising the outer diameter of each winding. In this configuration, the shearless boom 400 is not fully furled such that the distal ends of each of the first and second boom shells 402, 404 are not compressed and maintain their primary concave curvature. The distal end of the flexible sheath 406 may be generally aligned with the distal end of the second boom shell 404 resulting from longitudinal bunching of the inner surface of the flexible sheath 406 during furling. The curved edge of the bung portion 424 of the male half 420 of the cap 450 may be affixed (e.g., with adhesive) to the inner curved surface of the distal end of the second boom shell 404 with the post 422 extending proximally along the second boom shell 404 toward the furled portion of the shearless boom 400. Likewise, the curved edge of the bung portion 434 of the female half 430 of the cap 450 may be affixed (e.g., with adhesive) to the inner curved surface of the distal end of the first boom shell 402 with the post 432 extending proximally along the first boom shell 402 toward the furled portion of the shearless boom 400. During assembly of the shearless boom 400 in the unfurled state, the tongue 426 may be inserted into the groove 436 to join the male half 420 and the female half 430 of the cap 450.

During furling of the shearless boom 400, the tongue 426 of the male half 420 slides within the groove 436 of the female half 430 as the distal ends of the first and second boom shells 402, 404 longitudinally separate. The posts 422, 432 of the male half 420 and female half 430 of the cap 450 may be designed to extend for lengths that exceed the separation distance between the distal end of the first boom shell 402 and the distal end of the second boom shell 404 when the shearless boom 400 is in a furled state. If the posts 422, 432 are configured to be of such lengths, the distal end of the tongue 426 may remain partially inserted within the proximal end of the groove 436 when the shearless boom 400 is completely furled. As the shearless boom 400 is unfurled from the stowed configuration, the tongue 426 slides along and within the groove 436 until the entirety of the tongue 426 is within the entirety of the groove 436. The stop panel 438 prevents the tongue 426 from extending beyond the bung portion 434 of the female half 430 of the cap 450. In this way, the first and second boom shells 402, 404 are held within longitudinal registration when the shearless boom 400 is fully unfurled.

The interface between the tongue 426 of the male half 420 and the groove 436 of the female half 430 of the cap 450 further aids in maintaining lateral edge registration between the first and second boom shells 402, 404. The keyed interface between the tongue 426 of the male half 420 and the groove 436 of the female half 430 of the cap 450 resists torsional movement and slippage of the lateral edges of the first and second boom shells 402, 404 with respect to each other. As noted, the stop panel 438 further prevents excessive longitudinal travel of the first and second boom shells 402, 404 with respect to each other, thereby arresting potential shear forces along the shearless boom 400.

In one example implementation, a shearless extendible boom includes a first boom shell, a first structural form associated with the first boom shell, a second boom shell, a second structural form associated with the second boom shell, and a flexible sheath. The first boom shell extends along and about a first longitudinal axis. The first boom shell also has lateral longitudinal edges, and defines a first concavity in cross section. The second boom shell extends along and about a second longitudinal axis. The second boom shell also has lateral longitudinal edges, and defines a second concavity in cross section. The flexible sheath encases the first boom shell and the second boom shell. T he first and second longitudinal axes are parallel. The first concavity faces the second concavity. The lateral longitudinal edges of the first boom shell are aligned with and oppose the lateral longitudinal edges of the second boom shell, respectively. The first structural form and the second structural form are configured to form an interface with each other such that the interface resists torsional movement of the shearless extendible boom and inhibits slippage between corresponding lateral longitudinal edges of the first boom shell and the second boom shell.

In an example of a related implementation of the shearless extendible boom, the first structural form further comprises a respective convex curvature adjacent to each lateral longitudinal edge of the first boom shell to form first flared sections. The second structural form further comprises a respective convex curvature adjacent to each lateral longitudinal edge of the second boom shell to form second flared sections. Respective facing surfaces of the first flared sections and the second flared sections meet to form the interface to reduce slippage between respective lateral longitudinal edges of the first boom shell and the second boom shell along the interface and increase torsional stiffness and stability of the shearless extendible boom.

In an example of another related implementation of the shearless extendible boom, the first structural form further comprises a first series of holes defined within lateral walls of the first boom shell spaced apart longitudinally from each other as well as apart from and adjacent to the lateral longitudinal edges of the first boom shell. The second structural form further comprises a second series of holes defined within lateral walls of the second boom shell spaced apart longitudinally from each other as well as apart from and adjacent to the lateral longitudinal edges of the second boom shell. The interface further comprises a top stitch thread positioned on each outer lateral side of the shearless extendible boom and corresponding bottom threads positioned along inner lateral walls of each of the first boom shell and the second boom shell and aligned respectively with each of the first series of holes and the second series of holes. Each top stitch thread passes in and out of the first series of holes and the second series of holes in longitudinal sequence on respective lateral sides of the shearless extendible boom and loops around a respective bottom thread aligned with each of the first series of holes and the second series of holes to form a zig-zag stitch on each of the lateral sides of the shearless extendible boom to maintain the lateral longitudinal edges of each of the first boom shell and the second boom shell in registration with each other along respective longitudinal seams.

In an example of another related implementation of the shearless extendible boom, each of a plurality of holes in the first series of holes is positioned longitudinally between two adjacent holes in a plurality of the second series of holes and vice versa.

In an example of another related implementation of the shearless extendible boom, the first structural form comprises a male half of a cap affixed to a distal end of the first boom shell and the male half further defines a first engagement feature. The second structural form comprises a female half of the cap affixed to a distal end of the second boom shell and the female half further defines a second engagement feature. The first engagement feature and the second engagement feature are configured to moveably attach to each other and remain attached when the shearless extendible boom is in either a furled or unfurled configuration.

In an example of another related implementation of the shearless extendible boom, the male half of the cap defines a longitudinally extending tongue. The female half of the cap defines a longitudinally extending groove configured to slidably receive and retain the tongue. The tongue and the groove each extend for a longitudinal length that is greater than a separation distance of a distal end of the first boom shell and a distal end of the second boom shell when the shearless extendible boom is in a furled configuration.

In an example of another related implementation of the shearless extendible boom, the female half of the cap further defines a stop panel covering a distal end of the groove to prevent the tongue from extending beyond a distal end of the female half of the cap.

In an example of another related implementation of the shearless extendible boom, the first structural form further comprises a first corrugation formed in each lateral longitudinal edge of the first boom shell. The second structural form further comprises a respective, symmetric second corrugation formed each lateral longitudinal edge of the second boom shell. The first and second corrugations meet to form the interface to reduce slippage between respective lateral longitudinal edges of the first boom shell and the second boom shell along the interface and increase torsional stiffness and stability of the shearless extendible boom.

In an example of another related implementation of the shearless extendible boom, the first corrugation is formed as a first series of tabs and recesses; and the second corrugation is formed as second series of tabs and recesses symmetric to the first series.

In an example of a further related implementation of the shearless extendible boom, the first corrugation is formed as a first scalloped edge. The second corrugation is formed as second scalloped edge symmetric to the first scalloped edge.

In an example implementation, a method provides for maintaining lateral edge registration between a first boom shell and a second boom shell forming a shearless extendible boom. A first structural form associated with the first boom shell is provided. A second structural form associated with the second boom shell is provided. The first structural form and the second structural form are configured to form an interface with each other such that the interface resists torsional movement of the shearless extendible boom and inhibits slippage between corresponding lateral edges of first boom shell and the second boom shell.

In an example of another related implementation of the method, the first structural form further comprises a respective convex curvature adjacent to each lateral longitudinal edge of the first boom shell to form first flared sections. The second structural form further comprises a respective convex curvature adjacent to each lateral longitudinal edge of the second boom shell to form second flared sections. Respective facing surfaces of the first flared sections and the second flared sections are arranged to meet to form the interface to reduce slippage between respective lateral longitudinal edges of the first boom shell and the second boom shell along the interface and increase torsional stiffness and stability of the shearless extendible boom.

In an example of another related implementation of the method, the first structural form further comprises a first series of holes defined within lateral walls of the first boom shell spaced apart longitudinally from each other as well as apart from and adjacent to the lateral longitudinal edges of the first boom shell. The second structural form further comprises a second series of holes defined within lateral walls of the second boom shell spaced apart longitudinally from each other as well as apart from and adjacent to the lateral longitudinal edges of the second boom shell. A plurality of bottom threads along inner lateral walls of each of the first boom shell and the second boom shell are positioned to align, respectively, with each of the first series of holes and the second series of holesA respective top stitch thread is passed in and out of the first series of holes and the second series of holes in longitudinal sequence on outer surfaces of respective lateral sides of the shearless extendible boom and each top stitch thread is looped around a respective bottom thread aligned with each of the first series of holes and the second series of holes to form a zig-zag stitch on each of the outer surfaces of the lateral sides of the shearless extendible boom to maintain the lateral longitudinal edges of each of the first boom shell and the second boom shell in registration with each other along respective longitudinal seams to form the interface.

In an example of another related implementation of the method, each of a plurality of holes in the first series of holes is positioned longitudinally between two adjacent holes in a plurality of the second series of holes and vice versa.

In an example of another related implementation of the method, the first structural form comprises a male half of a cap with a first engagement feature. The second structural form comprises a female half of the cap with a second engagement feature. The male half of the cap is affixed to a distal end of the first boom shell. The female half of the cap is affixed to a distal end of the second boom shell. The first engagement feature and the second engagement feature are engaged to moveably attach to each other and remain attached when the shearless extendible boom is in either a furled or unfurled configuration.

In an example of another related implementation of the method, the male half of the cap defines a longitudinally extending tongue. The female half of the cap defines a longitudinally extending groove configured to slidably receive and retain the tongue. The tongue and the groove each extend for a longitudinal length that is greater than a separation distance of a distal end of the first boom shell and a distal end of the second boom shell when the shearless extendible boom is in a furled configuration.

In an example of another related implementation of the method, the female half of the cap further defines a stop panel covering a distal end of the groove. The tongue is blocked from extending beyond a distal end of the female half of the cap by interference with the stop panel.

In an example of another related implementation of the method, the first structural form further comprises a first corrugation formed in each lateral longitudinal edge of the first boom shell. The second structural form further comprises a respective, symmetric second corrugation formed each lateral longitudinal edge of the second boom shell. The first and second corrugations are arranged to meet to form the interface to reduce slippage between respective lateral longitudinal edges of the first boom shell and the second boom shell along the interface and increase torsional stiffness and stability of the shearless extendible boom.

In an example of another related implementation of the method, the first corrugation is formed as a first series of tabs and recesses. The second corrugation is formed as second series of tabs and recesses symmetric to the first series.

In an example of another related implementation of the method, the first corrugation is formed as a first scalloped edge. The second corrugation is formed as second scalloped edge symmetric to the first scalloped edge.

All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the structures disclosed herein, and do not create limitations, particularly as to the position, orientation, or use of such structures. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

The above specification, examples and data provide a complete description of the structure and use of exemplary embodiments of the invention as defined in the claims. Although various embodiments of the claimed invention have been described above with a certain degree of particularity, or with reference to one or more individual embodiments, other embodiments using different combinations of elements and structures disclosed herein are contemplated, as other iterations can be determined through ordinary skill based upon the teachings of the present disclosure. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A shearless extendible boom comprising
a first boom shell extending along and about a first longitudinal axis, having lateral longitudinal edges, and defining a first concavity in cross section;
a first structural form associated with the first boom shell;
a second boom shell extending along and about a second longitudinal axis, having lateral longitudinal edges, and defining a second concavity in cross section;
a second structural form associated with the second boom shell; and
a flexible sheath encasing the first boom shell and the second boom shell, wherein
the first and second longitudinal axes are parallel, the first concavity faces the second concavity, and the lateral longitudinal edges of the first boom shell are aligned with and oppose the lateral longitudinal edges of the second boom shell, respectively; and
the first structural form and the second structural form are configured to form an interface with each other such that the interface resists torsional movement of the shearless extendible boom and inhibits slippage between corresponding lateral longitudinal edges of the first boom shell and the second boom shell.

2. The shearless extendible boom of claim 1, wherein
the first structural form further comprises a respective convex curvature adjacent to each lateral longitudinal edge of the first boom shell to form first flared sections; and
the second structural form further comprises a respective convex curvature adjacent to each lateral longitudinal edge of the second boom shell to form second flared sections; and
respective facing surfaces of the first flared sections and the second flared sections meet to form the interface to reduce slippage between respective lateral longitudinal edges of the first boom shell and the second boom shell along the interface and increase torsional stiffness and stability of the shearless extendible boom.

3. The shearless extendible boom of claim 1, wherein
the first structural form further comprises a first series of holes defined within lateral walls of the first boom shell spaced apart longitudinally from each other as well as apart from and adjacent to the lateral longitudinal edges of the first boom shell;
the second structural form further comprises a second series of holes defined within lateral walls of the second boom shell spaced apart longitudinally from each other as well as apart from and adjacent to the lateral longitudinal edges of the second boom shell;
the interface further comprises a top stitch thread positioned on each outer lateral side of the shearless extendible boom and corresponding bottom threads positioned along inner lateral walls of each of the first boom shell and the second boom shell and aligned respectively with each of the first series of holes and the second series of holes; wherein
each top stitch thread passes in and out of the first series of holes and the second series of holes in longitudinal sequence on respective lateral sides of the shearless extendible boom and loops around a respective bottom thread aligned with each of the first series of holes and the second series of holes to form a zig-zag stitch on each of the lateral sides of the shearless extendible boom to maintain the lateral longitudinal edges of each of the first boom shell and the second boom shell in registration with each other along respective longitudinal seams.

4. The shearless extendible boom of claim 3, wherein each of a plurality of holes in the first series of holes is positioned longitudinally between two adjacent holes in a plurality of the second series of holes and vice versa.

5. The shearless extendible boom of claim 1, wherein
the first structural form comprises a male half of a cap affixed to a distal end of the first boom shell and the male half further defines a first engagement feature;
the second structural form comprises a female half of the cap affixed to a distal end of the second boom shell and the female half further defines a second engagement feature; wherein
the first engagement feature and the second engagement feature are configured to moveably attach to each other and remain attached when the shearless extendible boom is in either a furled or unfurled configuration.

6. The shearless extendible boom of claim 5, wherein
the male half of the cap defines a longitudinally extending tongue;
the female half of the cap defines a longitudinally extending groove configured to slidably receive and retain the tongue; and
the tongue and the groove each extend for a longitudinal length that is greater than a separation distance of a distal end of the first boom shell and a distal end of the second boom shell when the shearless extendible boom is in a furled configuration.

7. The shearless extendible boom of claim 6, wherein the female half of the cap further defines a stop panel covering a distal end of the groove to prevent the tongue from extending beyond a distal end of the female half of the cap.

8. The shearless extendible boom of claim 1, wherein
the first structural form further comprises a first corrugation formed in each lateral longitudinal edge of the first boom shell;
the second structural form further comprises a respective, symmetric second corrugation formed each lateral longitudinal edge of the second boom shell; and
the first and second corrugations meet to form the interface to reduce slippage between respective lateral longitudinal edges of the first boom shell and the second boom shell along the interface and increase torsional stiffness and stability of the shearless extendible boom.

9. The shearless extendible boom of claim 8, wherein
the first corrugation is formed as a first series of tabs and recesses; and
the second corrugation is formed as second series of tabs and recesses symmetric to the first series.

10. The shearless extendible boom of claim 8, wherein
the first corrugation is formed as a first scalloped edge; and
the second corrugation is formed as second scalloped edge symmetric to the first scalloped edge.

11. A method of maintaining lateral edge registration between a first boom shell and a second boom shell forming a shearless extendible boom, the method comprising
providing a first structural form associated with the first boom shell;
providing a second structural form associated with the second boom shell; and
configuring the first structural form and the second structural form to form an interface with each other such that the interface resists torsional movement of the shearless extendible boom and inhibits slippage between corresponding lateral edges of first boom shell and the second boom shell.

12. The method of claim 8, wherein
the first structural form further comprises a respective convex curvature adjacent to each lateral longitudinal edge of the first boom shell to form first flared sections; and
the second structural form further comprises a respective convex curvature adjacent to each lateral longitudinal edge of the second boom shell to form second flared sections; and
the configuring step further comprises arranging respective facing surfaces of the first flared sections and the second flared sections to meet to form the interface to reduce slippage between respective lateral longitudinal edges of the first boom shell and the second boom shell along the interface and increase torsional stiffness and stability of the shearless extendible boom.

13. The method of claim 8, wherein
the first structural form further comprises a first series of holes defined within lateral walls of the first boom shell spaced apart longitudinally from each other as well as apart from and adjacent to the lateral longitudinal edges of the first boom shell;
the second structural form further comprises a second series of holes defined within lateral walls of the second boom shell spaced apart longitudinally from each other as well as apart from and adjacent to the lateral longitudinal edges of the second boom shell; and
the configuring step further comprises
positioning a plurality of bottom threads along inner lateral walls of each of the first boom shell and the second boom shell to align, respectively, with each of the first series of holes and the second series of holes; and
passing a respective top stitch thread in and out of the first series of holes and the second series of holes in longitudinal sequence on outer surfaces of respective lateral sides of the shearless extendible boom and looping each top stitch thread around a respective bottom thread aligned with each of the first series of holes and the second series of holes to form a zig-zag stitch on each of the outer surfaces of the lateral sides of the shearless extendible boom to maintain the lateral longitudinal edges of each of the first boom shell and the second boom shell in registration with each other along respective longitudinal seams to form the interface.

14. The method of claim 10 further comprising positioning each of a plurality of holes in the first series of holes longitudinally between two adjacent holes in a plurality of the second series of holes and vice versa.

15. The method of claim 8, wherein
the first structural form comprises a male half of a cap with a first engagement feature;
the second structural form comprises a female half of the cap with a second engagement feature;
the configuring step further comprises
affixing the male half of the cap to a distal end of the first boom shell;
affixing the female half of the cap to a distal end of the second boom shell; and
engaging the first engagement feature and the second engagement feature to moveably attach to each other and remain attached when the shearless extendible boom is in either a furled or unfurled configuration.

16. The method of claim 12, wherein
the male half of the cap defines a longitudinally extending tongue;
the female half of the cap defines a longitudinally extending groove configured to slidably receive and retain the tongue; and
the tongue and the groove each extend for a longitudinal length that is greater than a separation distance of a distal end of the first boom shell and a distal end of the second boom shell when the shearless extendible boom is in a furled configuration.

17. The method of claim 13, wherein
the female half of the cap further defines a stop panel covering a distal end of the groove; and
the method further comprises blocking the tongue from extending beyond a distal end of the female half of the cap by interference with the stop panel.

18. The method of claim 11, wherein
the first structural form further comprises a first corrugation formed in each lateral longitudinal edge of the first boom shell; and
the second structural form further comprises a respective, symmetric second corrugation formed each lateral longitudinal edge of the second boom shell; and
the configuring step further comprises arranging the first and second corrugations to meet to form the interface to reduce slippage between respective lateral longitudinal edges of the first boom shell and the second boom shell along the interface and increase torsional stiffness and stability of the shearless extendible boom.

19. The method of claim 18, wherein the configuring step further comprises
forming the first corrugation as a first series of tabs and recesses; and
forming the second corrugation as second series of tabs and recesses symmetric to the first series.

20. The method of claim 18, wherein the configuring step further comprises
forming the first corrugation as a first scalloped edge; and
forming the second corrugation as second scalloped edge symmetric to the first scalloped edge.
